(19) United States
(12) Patent Application Publication
(10) Pub. No.: US 2003/0028673 A1
(43) Pub. Date: Feb. 6, 2003

(54) System and method for compressing and decompressing browser cache in portable, handheld and wireless communication devices

(75) Inventors: Rui Lin, San Diego, CA (US); Gary Wang, San Diego, CA (US); Harvey Zien, San Diego, CA (US)

Correspondence Address: Schwegman, Lundberg,, Woessner & Kluth, P.A., P.O. Box 2938, Minneapolis, MN, 55402, US

(73) Assignee: Intel Corporation

(21) Appl. No.: 09/920,223

(22) Filed: Aug. 1, 2001

(51) Int. Cl. G06F 15/16

(52) U.S. Cl. 709/247; 709/218

(57) ABSTRACT

Improved browser caching performance in portable, handheld and wireless communication devices has been achieved by ASIC compression and decompression engines that compress cache content resulting in a more efficient use of the limited memory of such devices. Based on a data type, the compression engine selects an appropriate compression accelerator which invokes a corresponding compression algorithm, to compress the cache data. The process is reversed when the cache is requested by the browser.

### FIELD OF THE INVENTION

This invention relates in general to the field of wireless communication devices, in particular to wireless communication devices that provide internet type network access, and more particularly to wireless, handheld and portable communication devices that have a need to cache web pages.

### BACKGROUND OF THE INVENTION

Caching is a process that web browsers typically use that provides for faster retrieval of web page content. When a user accesses a web page, a cache engine locally stores the page's content including graphics and HTML text. Later, when the same web page is accessed, the content for that web page is pulled from a memory. This process improves download time and reduces network bandwidth usage. Web requests are redirected to a cache engine to retrieve the content from cache memory rather than from over the network.

Caching places information closer to the user's device in order to make the information more readily and speedily accessible, and does this transparently. At the same time, the use of cached content places less strain on the limited input and output elements (I/O) of the user device's resources and the network's resources. Although caching provides significant benefits in wired computing environments, portable devices and systems that operate in a wireless environment would benefit even more from caching especially because of additional time required to retrieve content from the network source due to, for example, reduced bandwidth and lower reliability of wireless links.

One problem with caching web page content is that caching requires a significant amount of memory resources. Memory resources are usually not a major concern for most proxy servers, computer systems and personal computers because memory is fairly inexpensive and the additional space required for additional memory is available. Memory space, however, is a major concern for portable, handheld and wireless communication devices. Portable devices, and especially handheld and wireless devices, typically have significantly less memory available because of size, weight and power constraints, making it difficult to support the high memory requirements of browser caching. As a result, the browser performance of portable, handheld and wireless communication devices is often poor.

Thus what is needed is a method and system for providing improved browser performance in portable, handheld and wireless communication devices. What is also needed is a method and system that efficiently uses the limited memory of portable, handheld and wireless communication devices. What is also needed is a method and system that provides improved browser caching for portable, handheld and wireless communication devices.

### BRIEF DESCRIPTION OF THE DRAWINGS

The invention is pointed out with particularity in the appended claims. However, a more complete understanding of the present invention may be derived by referring to the detailed description and claims when considered in connection with the figures, wherein like reference numbers refer to similar items throughout the figures and:

FIG. 1 is a simplified functional block diagram of a portion of a communication device in accordance with one embodiment of the present invention;

FIG. 2 is a simplified functional block diagram of a compression engine in accordance with one embodiment of the present invention;

FIG. 3 is a simplified functional block diagram of a decompression engine in accordance with one embodiment of the present invention;

FIG. 4 is a simplified functional block diagram of a cache management architecture in accordance with one embodiment of the present invention;

FIG. 5 is a simplified flow chart of a cache compression and storage procedure in accordance with one embodiment of the present invention; and

FIG. 6 is a simplified flow chart of a cache retrieval and decompression procedure in accordance with one embodiment of the present invention.

The description set out herein illustrates several embodiments of the invention in one form thereof, and such description is not intended to be construed as limiting in any manner.

### DETAILED DESCRIPTION OF THE DRAWINGS

The present invention provides, among other things, a method and system that improves browser caching, and is especially suitable for portable, handheld and wireless communication devices. The available memory is more efficiently utilized and browser performance is significantly improved. In accordance with one of the embodiments, a compression engine and a decompression engine are employed to compress and decompress cache content. The cache is stored in a compressed form in a cache memory of the hand-held device. The compression engine invokes one of several compression accelerators based on the type of data to be compressed. Each compression accelerator implements a particular compression algorithm in hardware. Accordingly, compressing cache content is done rapidly and transparently to the user while the amount of cached content for use by a browser is significantly increased.

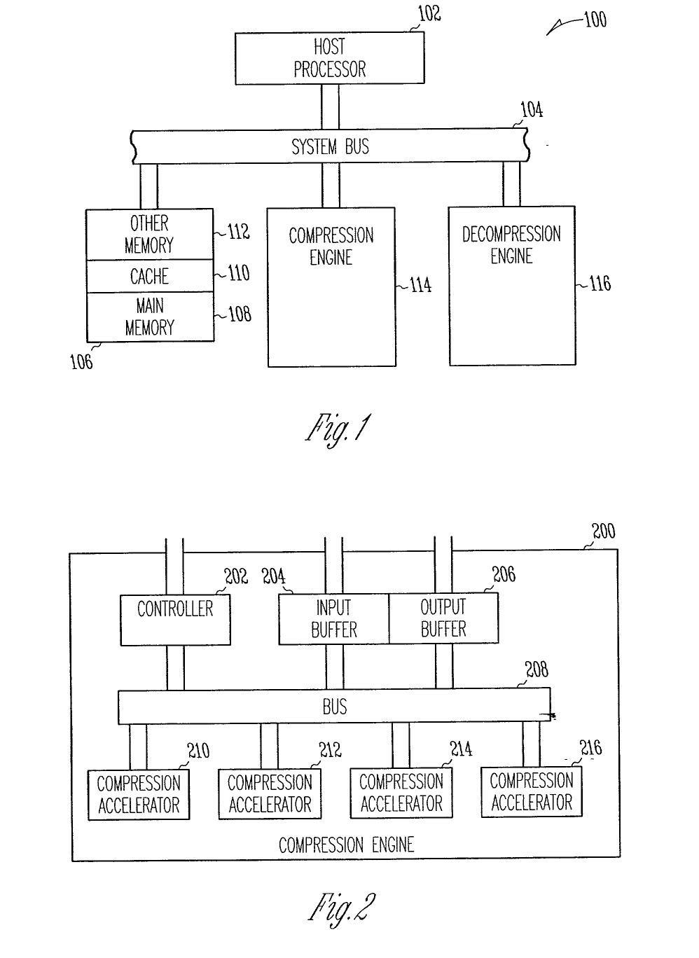

FIG. 1 is a simplified functional block diagram of a portion of a communication device in accordance with one embodiment of the present invention. Portion 100 may be a portion of any communication device that provides for digital communications. Although the present invention is equally applicable to any communication device, the advantages of the present invention are most applicable to portable, handheld and wireless communication devices. By way of example, portable, handheld and wireless communication devices include wireless and cellular telephones, smart phones, personal digital assistants (PDA's), web-tablets, and any device that provides access to a network such as an intranet or the internet.

Portion 100 comprises host processor 102 that controls operations of the communication device. Host processor 102 runs, among other things, firmware as well as browser-type software. Not shown in portion 100 are other system components that are typical in wireless, handheld and portable devices. Other system components, may include, for example, transceivers for communicating information over wireless links, a power source such as a battery, I/O elements, a display and user interface, as well as other elements common in communication devices. System bus 104 couples host processor 102 with memory 106, compression engine 114 and decompression engine 116. Memory 106 includes cache memory 110, a main memory 108 and other memory 112.

Processor 102 may be any processor or microprocessor including the XScale and ARM 7 processors, or processors based on the Micro-Signal Architecture (MSA) by Intel. Bus 104 may be a PCI type bus or other bus suitable for transferring information in accordance with the present invention including PX type buses. Memory 106 may be virtually any type of memory and is desirably comprised of flash-type memory, however SRAM, Electronically Erasable Programmable Read Only Memory (EEPROM) and others are equally suitable. It should be noted that FIGS. 1-3 illustrate functional block diagrams rather than physical diagrams. Accordingly, any of the functional elements may be implemented in as single or combined hardware elements. Compression engine 114 and decompression engine 116 are desirably implemented on a single Application Specific Integrated Circuit (ASIC), although other implementations are equally suitable. For example, compression engine 114 and decompression engine 116 may be implemented as separate ASIC devices.

In accordance with one of the embodiments of the present invention, when the communication device is, for example, operating a web browser, the web-browser software will typically initiate a request to cache the content of a web page. In response, compression engine 114 receives web page content over bus 104 and compresses the web page content. The compressed web page content is transferred back over bus 104 and stored in cache memory 110. When the web-browser software requests retrieval of the cache for a web page, the compressed web page content is identified in cache memory 110 and transferred to decompression engine 116 where it is decompressed and provided back to web browser software. As used herein, the compression and decompression of data refers equally to the compression and decompression of any digital or digitized information including digital data, text, interpreted data, graphics, images, music, speech, etc.

One goal of data compression is to reduce the number of bits required to represent data. Typically, data compression methods which provide the highest levels of data compression generally require the most complex data processing equipment and are often slow in execution. Those methods which offer lower levels of data compression often operate faster and employ less complex hardware. In general, the choice of a data compression method is made based upon a compromise between system complexity and time of execution versus desired level of data compression.

In accordance with one embodiment of the present invention, compression engine 114 employs a plurality of hardware implemented compression accelerators which are dedicated to a particular type of data compression, while decompression engine 116 employs a plurality of hardware implemented decompression accelerators which are dedicated to a particular type of data decompression. This provides for fast and efficient data compression and decompression, because a hardware implementation is faster than a typical software implementation, different algorithms are more efficient and better suited for certain types of data, and the accelerators may operate on different portion of the data in parallel.

There are several known data compression techniques. For example, a two dimensional coding scheme discussed in the review paper entitled “Coding of Two-Tone Images”, Hwang, IEEE Transactions on Communications, Vol. COM-25, No. 11, November, 1977, pp. 1406-1424, which describes a number of techniques for efficient coding of both alphanumeric data and image data. Both single dimension (run length) and two-dimension coding (e.g. per block of pixel data) are considered. Another two dimensional coding scheme is described by Hunter et al. in “International Digital Facsimile Coding Standards”, Proceedings of the IEEE, Vol. 68, No. 7, July, 1980, pp. 854-867 which describes various algorithms used in facsimile transmission (generally one-dimension coding techniques). In these two-dimension coding schemes, conditions of a subsequent coding line are encoded in dependence upon conditions in a previous reference line.

Another compression technique has been described in a paper entitled “An Extremely Fast Ziv-Lempel Data Compression Algorithm” by Williams, Proceedings of the IEEE Data Compression Conference, April, 1991, pp. 362-371, which describes a fast implementation of the Lempel-Ziv (LZ) compression algorithm that employs the LZ method. That method constructs a dictionary of data strings at both the receiving and transmitting nodes and transmits codes in dependence upon matches found between an input data string and a data string found in the dictionary.

FIG. 2 is a simplified functional block diagram of a compression engine in accordance with one embodiment of the present invention. Compression engine 200 comprises a plurality of compression accelerators 210, 212, 214 and 216, each for implementing a predetermined compression algorithm. Desirably, compression accelerators 210, 212, 214 and 216 implement compression algorithms in custom designed hardware. Compression engine 200 also comprises input buffer 204 and output buffer 206 which couple with compression accelerators 210, 212, 214 and 216 through bus 208. Input buffer 204 and output buffer 206 are coupled to an external bus, such as bus 104 (FIG. 1). Data for compression by compression engine 200 is buffered in input buffer 204 by a host processor such as host processor 102 (FIG. 1), while data that has been compressed is buffered in output buffer 206 for transfer to a storage location such as cache memory 110 (FIG. 1). Compression engine 200 is suitable for use as compression engine 114 (FIG. 1).

In accordance with one of the embodiments of the present invention, web page content to be cached is transferred to input buffer 204, and one of compression accelerators 210, 212, 214 and 216 is selected and invoked depending on the data type to be compressed. Different compression accelerators may be invoked for different data types present in a web page.

In accordance with one embodiment, a host processor or other processing element external to compression engine 200 determines which of the compression accelerators to invoke based on the data type. In accordance with one embodiment, compression engine includes controller 202 which includes a data analyzer element that identifies the data types present in the web page content. Controller 202 also includes a selector element that selects an appropriate one of the compression accelerators 210, 212, 214 and 216, invokes the selected compression accelerator, and desirably notifies a host processor when the compressed data is ready in output buffer 206. In this embodiment, controller 202 receives instructions from and communicates with an external host processor over a bus such as bus 104 (FIG. 1).

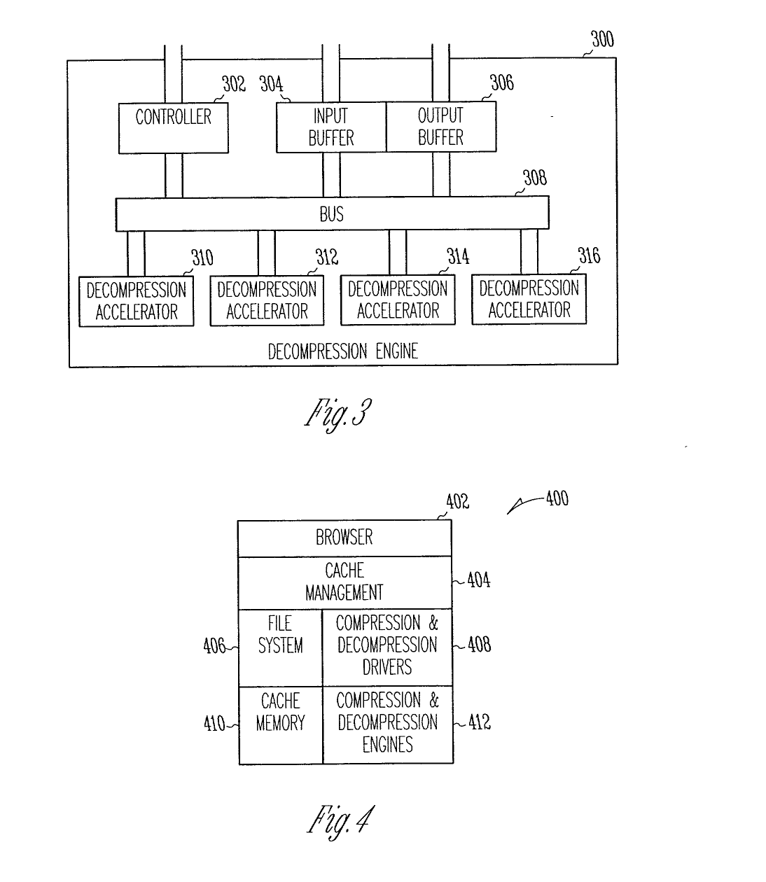

FIG. 3 is a simplified functional block diagram of a decompression engine in accordance with one embodiment of the present invention. Decompression engine 300 comprises a plurality of decompression accelerators 310, 312, 314 and 316, each for implementing a predetermined decompression algorithm and each desirably corresponding with one of the compression accelerators of compression engine 200 (FIG. 2). Desirably, decompression accelerators 310, 312, 314 and 316 implement decompression algorithms in custom designed hardware. Decompression engine 300 also comprises input buffer 304 and output buffer 306 which couple with decompression accelerators 310, 312, 314 and 316 through bus 308. Input buffer 304 and output buffer 306 are coupled to an external bus, such as bus 104 (FIG. 1). Data for decompression by compression engine 300 is buffered in input buffer 304 by a host processor, such as host processor 102 (FIG. 1), while data that has been decompressed is buffered in output buffer 306 for transfer to the browser software. Decompression engine 300 is suitable for use as decompression engine 116 (FIG. 1).

In accordance with one of the embodiments of the present invention, web page content to be retrieved from cache memory is transferred to input buffer 304 by a host processor. One of decompression accelerators 310, 312, 314 and 316 is selected and invoked depending on the data type to be decompressed. Different decompression accelerators are desirably invoked for different data types present in the compressed web page.

In accordance with one embodiment, a host processor or other processing element external to decompression engine 300 determines which of the decompression accelerators to invoke based on the data type. In accordance with one embodiment, the compression engine includes controller 302 which includes a data analyzer element that identifies the data types present in the compressed web page content. Controller 302 also includes a selector element that selects an appropriate one of the decompression accelerators 310, 312, 314 and 316, invokes the selected decompression accelerator, and desirably notifies a host processor when the decompressed data is ready in output buffer 306. In this embodiment, controller 302 receives instructions from and communicates with an external host processor over a bus, such as bus 104 (FIG. 1).

In the various embodiments of the present invention, compression engine 200 and decompression engine 300 comprise one or more hardware accelerators (i.e., respectively compression accelerators 210, 212, 214 and 216, and decompression accelerators 310, 312, 314 and 316) that perform a serial dictionary based algorithm, such as the LZ77 or LZ-Stac (LZs) dictionary based compression and decompression algorithms. The accelerators may also implement the LZ78, LZ-Welsh (LZW), LZs, LZ Ross Williams (LZRW1) and/or other algorithms. Desirably, each compression accelerator (and an associated decompression accelerator) are designed to implement one algorithm in hardware. Accordingly, compression engine 200 (and decompression engine 300) may have many compression (and decompression) accelerators depending on the number of compression (or decompression) algorithms that are implemented.

In accordance with one embodiment, the content of the web page comprises a plurality of data types. Each data type is identifiable, desirably with a data type tag associated therewith. The controller reads the tag and selects one of the compression accelerators for each data type. In this embodiment, the first of the compression accelerators 210 is configured to hardware implement a first compression algorithm for a first of the data types, and a second of the compression accelerators 212 is configured to hardware implement a second compression algorithm for a second of the data types. The first and second data types are distinct, and the first and second compression algorithms are distinct.

Accelerators based on one of the LZ type algorithms, for example, the LZ77 are invoked to compress, for example, text data, HTML data, XML data, XHTML data, interpreted data, portable network graphics (PNG) data. Accelerators based on the LZW, for example, may be implemented for data types such as graphic interface format (GIF) data, while accelerators based on the LZH algorithm may be implemented for LZH data, joint photographic experts group (JPEG), and moving pictures experts group (MPEG) data including MPEG Layer-3 (MP3) data and MPEG Layer-4 (MP4) data. Accelerators based on the LZ77, for example, may also be implemented for data types such as JAR and ZIP data, as well as for data types such as SQZ data, UC2 data, ZOO data, ARC data, ARJ data and PAK data. Accelerators may also implement any of the other LZ algorithms for compressing the various data types.

In one embodiment, the first compression accelerator 210 implements the LZ77 compression algorithm for a first group of data types that include PNG data, the second compression accelerator 212 implements a LZW compression algorithm for a second group of data types that include GIF data. A third compression accelerator 214 may be included to hardware implement a third compression algorithm for compressing a third group of data types including JPEG or MPEG data. In one embodiment, another compression accelerators may be configured to hardware implement the LZ77 compression algorithm for a fourth group of data types. In these various embodiments of the present invention, decompression engine 300 (FIG. 3) includes decompressing accelerators that correspond with each of the compression accelerators for decompressing data compressed by the corresponding compression accelerator.

In situations where portions of web content are received in a compressed form, the controller refrains from invoking one of the compression accelerators. In this case, controller 202 recognizes the data as compressed or as a compressed object and causes these pre-compressed objects to be transferred to the cache memory without processing by any of the hardware accelerators. Controller 302 desirably recognizes pre-compressed objects that are stored in cache memory and refrains from invoking one of the decompression accelerators for these objects. In one alternate embodiment, controller 302 may invoke the appropriate decompression accelerator (based on the data type or tag) for such pre-compressed objects that are stored in cache memory as well as for pre-compressed objects received directly from an external source such as a web-site.

In one embodiment, the accelerators implement a parallel lossless compression algorithm, and desirably a “parallel” dictionary-based compression and decompression algorithm. The parallel algorithm may be based on a serial dictionary-based algorithm, such as the LZ77 or LZSS algorithms. The parallel algorithm may also be based on a variation of conventional serial LZ compression, including LZ77, LZ78, LZ-Welsh (LZW), LZ-Stac (LZs) and/or LZRW1, among others. The parallel algorithm could also be based on Run Length Encoding, Predictive Encoding, Huffman, Arithmetic, or any other compression algorithm or lossless compression algorithm. However, the paralleling of these is less preferred due to their lower compression capabilities and/or higher hardware costs.

Any of various compression methods may be implemented by the present invention, however parallel implementations are desirably used, although other compression methods that provide fast parallel compression and decompression for improved memory bandwidth and efficiency are also suitable for use with the present invention.

In accordance with one of the embodiments of the present invention, compression engine 114 and decompression engine 116 are configured to implement several algorithms that in addition to those method described above, include the LZ, LZ77, LZ78, LZH, LZS, LZW, LZRW and LZRW1 algorithms. The present invention may employ any of a number of compression schemes and is equally applicable to other known compression methods as well as to compression methods yet unknown or unpublished.

In accordance with one embodiment of the present invention, improved performance is achieved by caching interpreted data. This avoids reinterpretation when retrieving the data. Interpreted data includes, for example, data such as codes that are hidden in a web page and cause the web browser to interpret information that follows in a certain way. When a web page is downloaded over a network connection, the interpreted data (such as HTML codes) is interpreted by the browser and displayed in accordance with the interpretation. The same occurs when the web page is retrieved from cache. In accordance with this embodiment of the present invention, the web page is compressed after interpretation of the interpreted data. In this way, the interpreted data is not compressed but it is the result of the interpreted data on the other data that is compressed. Accordingly, re-interpretation of interpreted data is avoided when retrieving the compressed web page from cache memory.

FIG. 4 is a simplified functional block diagram of a cache management architecture in accordance with one embodiment of the present invention. Architecture 400 manages the compressing and caching of content as well as the retrieving and decompressing of cache content. File system 406 is desirably used for writing data to cache memory 410 and for reading data from cache memory 410. File system 406 is also used for updating data in a cache directory. Architecture 400 comprises browser portion 402, a virtual cache management module portion 404, file system 406, and compression and decompression drivers 408. While browser portion 402, cache management portion 404, file system 406, and compression and decompression drivers 408 are desirably implemented in software and firmware that operate on a communication device, cache memory 410 and compression and decompression engines 412 are hardware elements invoked by file system 406 and drivers 408 respectively. Cache memory 410, for example, corresponds with cache memory 110 (FIG. 1), and compression and decompression engines 412, for example, correspond respectively with compression and decompression engines 114 and 116 (FIG. 1).

When browser 402 wants to cache data, virtual cache management module 404 passes the data to compression engine 412 using compression driver 408 to invoke the compression function. Compression driver 408 is desirably an accelerator driver for invoking one of the compression accelerators, such as compression accelerators 210, 212, 214 and/or 216 (FIG. 2). Compression driver 408 may be implemented as part of controller 202 (FIG. 2) or in an alternative embodiment, may be implemented by a host processor external to compression engine 200 (FIG. 2). The compressed data is then written to cache memory 410 using file system 406.

Similarly, when browser 402 wants to retrieve cached data, virtual cache management module 404 fetches the compressed data from cache memory 410 using file system 406, passes the compressed data to decompression engine 412 using decompression driver 408 which invokes a decompression function. Decompression driver 408 is desirably an accelerator driver for invoking one of the decompression accelerators, such as decompression accelerators 310, 312, 314 and/or 316 of (FIG. 3). Decompression driver 408 may be implemented as part of controller 302 (FIG. 3) or in an alternative embodiment, may be implemented by a host processor external to decompression engine 300 (FIG. 3). The decompressed data is then passed to browser 402.

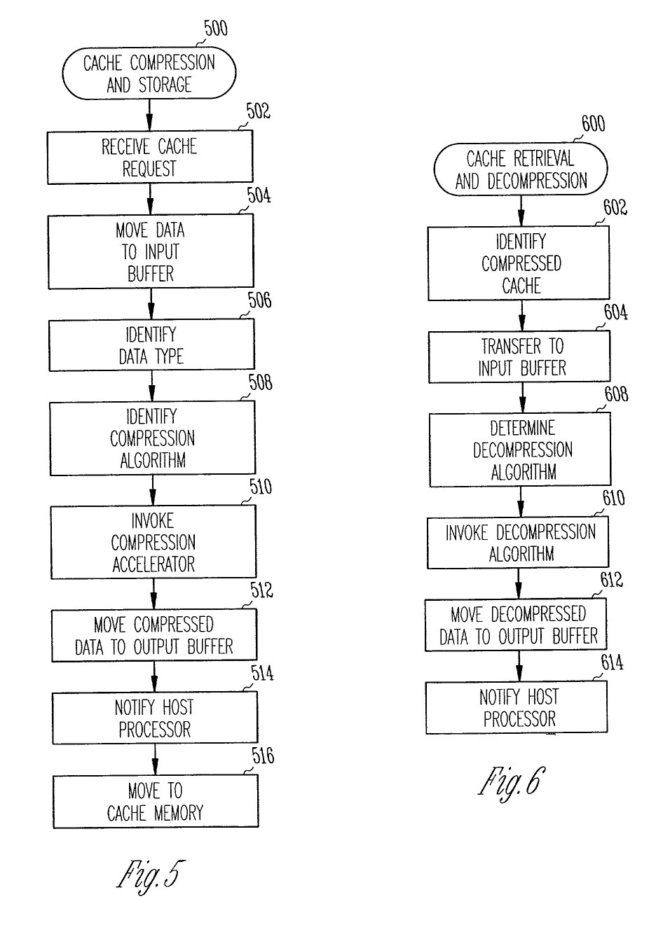

FIG. 5 is a simplified flow chart of a cache compression and storage procedure in accordance with one embodiment of the present invention. Procedure 500 is desirably performed by portions of virtual cache memory architecture 400 (FIG. 4) as well as the functional elements of system 100 (FIG. 1). In task 502, a cache request is received from the browser. For example, in accordance with web browser software, a web page or portions thereof are requested to be cached. In task 504, the data is moved to the input buffer of the compression engine. In task 506, data types are identified for each portion of data of the web page to be cached. Task 506 identifies, for example, portable network graphics (PNG) data, graphic interface format (GIF) data, joint photographic experts group (JPEG), moving pictures experts group (MPEG) data, JAR and/or ZIP data types. Task 506 also identifies which of the data (i.e., objects) that are received by the browser in compressed form (e.g., pre-compressed).

In task 508, a compression algorithm is selected based on the data type. The compression algorithm corresponds with a particular compression accelerator that implements the identified algorithm in hardware (e.g., without intervention of software). In task 510, the compression accelerator for the identified algorithm is invoked for each of the different data types. The identified compression accelerator compresses the data. In task 512, the compressed data is moved to the output buffer and in task 514, the host is notified that compressed data is ready. In task 516, the compressed data is moved to the cache memory.

In one embodiment, for data that was identified in task 506 as being pre-compressed, procedure 500 refrains from performing tasks 508 and 510, and the pre-compressed data is moved directly to output buffer. In an alternate embodiment, pre-compressed data portions of a web page are transferred directly to the cache memory without the involvement of the compression engines.

FIG. 6 is a simplified flow chart of a cache retrieval and decompression procedure in accordance with one embodiment of the present invention. Procedure 600 is desirably performed by portions of virtual cache memory architecture 400 (FIG. 4) as well as the functional elements of system 100 (FIG. 1). In task 602, when the browser requests retrieval of cached data for a web page, the compressed cached data is identified in the cache memory. In task 604, the identified compressed cached data is transferred to an input buffer of the decompression engine. In task 608, a decompression algorithm is selected for each data type of compressed cached data (e.g., portions of a web page may be comprised of different data types) based on a data type tag. In task 610, one of the decompression accelerators that perform the identified decompression algorithm is invoked for each of the different data types. The compressed data is then decompressed, and in task 612, decompressed data from the decompression accelerator is transferred to an output buffer of the decompression engine. In task 614, the host processor is notified that the cached content is ready for the browser.

In one embodiment, pre-compressed objects that are stored in cache memory are recognized as such. Accordingly, procedure 600 may refrains from performing task 610 for these recognized pre-compressed objects, allowing the decompression to be performed by the browser software. In one alternate embodiment, an appropriate decompression accelerator may be used for decompressing such pre-compressed objects that are stored in cache memory as well as used for decompressing pre-compressed objects received directly from an external source such as a web-site. In this way, the browser software does not have to decompress these pre-compressed objects allowing for faster and more efficient retrieval of cached web pages.

Thus, a method and system that provides improved browser performance in portable, handheld and wireless communication devices has been described. The method and system more efficiently uses the limited memory of portable, handheld and wireless communication devices, and improved browser caching for portable, handheld and wireless communication devices is achieved.

The foregoing description of the specific embodiments will so fully reveal the general nature of the invention that others can, by applying current knowledge, readily modify and/or adapt for various applications such specific embodiments without departing from the generic concept, and therefore such adaptations and modifications should and are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations that fall within the spirit and broad scope of the appended claims.

What is claimed is:

1. A method for caching web page on a wireless communication device comprising:
receiving web page content over a wireless link;
compressing a portion of the web page content in response to a request to cache; and
decompressing a compressed portion of the web page content in response to a request to retrieve cache.

2. The method as claimed in claim 1 wherein the compressing comprises invoking one of a plurality of compression accelerators to compress the portion the web page content based on a data type of the portion, and wherein the decompressing comprises invoking one of a plurality of decompression accelerators to decompress the compressed portion of the web page content based on a data type of the compressed portion.

3. The method as claimed in claim 2 further comprises:
invoking a first of the compression accelerators for the portions of the web page content of a first data type;
invoking a second of the compression accelerators for the portions of the web page content of a second data type;
invoking a first of the decompression accelerators for the compressed portions of the web page content of the first data type; and
invoking a second of the decompression accelerators for the compressed portions of the web page content of the second data type.

4. The method as claimed in claim 1, further comprising as part of a caching operation:
transferring the portions of the web page content to be cached to a compression engine input buffer; and
transferring, subsequent to compression, the compressed portions of the web page content from a compression engine output buffer to the cache memory;
and as part of cache retrieval operation:
retrieving the compressed portions of the web page content from a cache memory;
transferring the compressed portions of the web page content to a decompression engine input buffer; and
retrieving decompressed portions of the web page content from a decompression engine output buffer.

5. A system for caching a web page comprising:
a compression engine compressing portions of web page content responsive to a request to cache the web page, the compression engine comprising a plurality of compression accelerators wherein at least one of the compression accelerators is invoked to compress one of the portions based on a data type of the portion; and
a decompression engine decompressing compressed portions of the web page content from a cache memory, the decompression engine comprising a plurality of decompression accelerators wherein at least one of the decompression accelerators is invoked to decompress one of the compressed portions based on a data type of the compressed portion.

6. The system as claimed in claim 5 wherein:
the compression engine invokes a first of the compression accelerators for portions of the web page content of a first data type and invokes a second of the compression accelerators for portions of the web page content of a second data type, and
the decompression engine invokes a first of the decompression accelerators for the compressed portions of the web page content of the first data type and invokes a second of the compression accelerators for the compressed portions of the web page of the second data type.

7. The system as claimed in claim 6 wherein:
the compression engine comprises:
a compression engine controller to invoke one of the compression accelerators based on the data type;
a compression engine input buffer to store the content prior to compression by the compression accelerators; and
a compression engine output buffer to store compressed content received from the compression accelerators, and
the decompression engine comprises:
a decompression engine controller to invoke one of the decompression accelerators based on the data type;
a decompression engine input buffer to store the compressed portions of the content prior to decompression by the decompression accelerators; and
a decompression engine output buffer to store decompressed portions of the content subsequent to decompression.

8. The system as claimed in claim 7 further comprising:
a host processor; and
a cache memory,
wherein as part of a caching operation, the host processor transfers the portions of the web page content to be cached to the compression engine input buffer, and subsequent to compression, transfers the compressed portions of the web page content from the compression engine output buffer to the cache memory, and
wherein as part of cache retrieval operation, the host processor retrieves the compressed portions of the web page content from cache memory, transfers the compressed portions of the web page content to the decompression engine input buffer, and retrieves decompressed portions of the web page content from the decompression engine output buffer.

9. A compression engine comprising:
a plurality of compression accelerators; and
a controller identifying a data type for portions of content of a web page to be cached, and invoking one of the compression accelerators of the plurality based on the data type.

10. The compression engine as claimed in claim 9 wherein the content of the web page comprises a plurality of data types, and wherein the controller selects one of the compression accelerators for each data type.

11. The compression engine as claimed in claim 9 wherein each compression accelerator of the plurality is configured to implement one of a plurality of predetermined compression algorithms.

12. The compression engine as claimed in claim 9 further comprising:
an input buffer to store the content prior to compression by the compression accelerators; and
an output buffer storing compressed content received from the compression accelerators.

13. The compression engine as claimed in claim 9 wherein the content of the web page comprises a plurality of data types, each data type having a data type tag associated therewith, and wherein the controller reads the tag and selects one of the compression accelerators for each data type, and wherein:
a first of the compression accelerators is configured to implement in hardware a first compression algorithm for a first of the data types; and
a second of the compression accelerators is configured to implement in hardware a second compression algorithm for a second of the data types,
wherein the first and second data types are distinct, and the first and second compression algorithms are distinct.

14. The compression engine as claimed in claim 13 wherein the first compression algorithm is a Lempel-Ziv 77 (LZ77) compression algorithm, and the first data type comprises portable network graphics (PNG) data.

15. The compression engine as claimed in claim 13 further comprising a third compression engine configured to hardware implement a third compression algorithm for third data types of the group consisting of either joint photographic experts group (JPEG) or moving pictures experts group (MPEG) data.

16. The compression engine as claimed in claim 14 wherein the second compression algorithm is a LZW compression algorithm, and the second data type comprises graphic interface format (GIF) data.

17. The compression engine as claimed in claim 9 wherein the controller refrains from invoking one of the compression accelerators for portions of the content received in compressed form.

18. A decompression engine comprising:
a plurality of decompression accelerators; and
a controller to identify a data type for compressed portions of content of a web page to be retrieved, and to invoke one of the decompression accelerators of the plurality based on the data type.

19. The decompression engine as claimed in claim 18 wherein the compressed portions of content of the web page comprises a plurality of data types, each data type having a data type tag associated therewith, and wherein the controller reads the tag and selects one of the decompression accelerators for each data type.

20. The decompression engine as claimed in claim 18 wherein each decompression accelerator of the plurality is configured to implement one of a plurality of predetermined decompression algorithms.

21. The decompression engine as claimed in claim 18 further comprising:
an input buffer to store the compressed portions of the content prior to decompression by the decompression accelerators; and
an output buffer to store decompressed portions of the content subsequent to decompression.

22. The decompression engine as claimed in claim 18 wherein the compressed portions of content of the web page comprises a plurality of data types, each data type having a data type tag associated therewith, and wherein the controller reads the tag and selects one of the decompression accelerators for each data type, and wherein:
a first of the decompression accelerators is configured to hardware implement a first decompression algorithm for a first of the data types; and
a second of the decompression accelerators is configured to hardware implement a second decompression algorithm for a second of the data types,
wherein the first and second data types are distinct, and the first and second decompression algorithms are distinct.

23. The decompression engine as claimed in claim 22 wherein the first decompression algorithm is a Lempel-Ziv 77 (LZ77) decompression algorithm, and the first data type comprises portable network graphics (PNG) data.

24. The decompression engine as claimed in claim 23 wherein the second decompression algorithm is a LZW decompression algorithm, and the second data type comprises graphic interface format (GIF) data.

25. The decompression engine as claimed in claim 22 further comprising a third decompression engine configured to hardware implement a third decompression algorithm for third data types of the group consisting of either joint photographic experts group (JPEG) or moving pictures experts group (MPEG) data.
